(19) United States
(12) Patent Application Publication
(10) Pub. No.: US 2003/0172497 A1
(43) Pub. Date: Sep. 18, 2003

(54) Hinge device for use in electric equipment

(76) Inventor: Baeg Soon Cha, Incheon (KR)

Correspondence Address: Joseph W. Berenato, III, Liniak, Berenato & White, LLC, Suite 240, 6550 Rock Spring Drive, Bethesda, MD, 20817, US

(21) Appl. No.: 10/280,083

(22) Filed: Oct. 25, 2002

Related U.S. Application Data
(63) Continuation-in-part of application No. 10/120,839, filed on Apr. 12, 2002.

(30) Foreign Application Priority Data
Mar. 12, 2002 (KR) 2002-13388

(51) Int. Cl. E05D 11/08

(52) U.S. Cl. 16/342

(57) ABSTRACT

A hinge device for use in an electric or electronic apparatus is provided, in which a pivoting portion moves with respect to a fixed portion around a hinge portion. The hinge device for generating a predetermined pivoting movement according to the movement of the pivoting portion, includes a lower bracket; vertical plates which are vertically and opposingly installed with respect to each other on the central portion of the lower bracket, each vertical plate having an inwardly protruding stopper on the upper portion thereof; a rotational axle around the center portion of which a coil spring is wound to support the lower bracket and an upper bracket, and around the axle groove of which a snap ring is fitted, the rotational axle being placed across the upper portions of the vertical plates; a connection plate placed across the upper portions of the vertical plates, the connection plate having a fixing hole and a fixing unit on each end thereof; a band spring which is fitted into each end of the rotational axle, an engagement unit being attached to the band spring and being adjusted with washers and an adjustment bolt; and the upper bracket having two supporters each of which has a holder including an upper contacting portion and a lower contacting portion which contact the protruding stopper respectively and an axle hole through which the rotational axle is fitted. Accordingly, the hinge device has effects of a simple assembly and an easy maintenance. Also, the hinge device plays a role of a hinge which can freely adjust a torque transferred to the rotational axle to thus generate a proper frictional force constantly and adjust a rotational angle according to an angle formed by the upper and lower contacting portions of the holder.

### BACKGROUND OF THE INVENTION

1. Field of the Invention

The present invention relates to a hinge device, and more particularly, to a hinge device connecting a fixed portion and a pivoting portion in electric or electronic equipment in order to rotate in a certain direction, which has effects of a simple assembly and an easy maintenance, and can freely adjust a torque transferred to the rotational axle to thus generate a proper frictional force constantly and adjust a rotational angle according to an angle formed by the upper and lower contacting portions of the holder.

2. Description of the Related Art

In a general hinge device, a pivoting portion moves with respect to a fixed portion around a hinge portion, in which a predetermined pivoting movement is generated according to the movement of the pivoting portion. In particular, a hinge device used for an electric appliance applies a frictional force to a rotational axle in most cases by using an engagement force formed by adjusting tightening of washers and a bolt at each end of the rotational axle. In this case, the frictional forces applied to both ends of the rotational axle do not equal, and also an external force should be adjusted and applied to both ends of the rotational axle through a complicated procedure.

Also, a separate stopper bracket and a pivoting bracket should be provided in the rotational axle, in order to determine the rotational angle of the pivoting portion. Further, a connection relationship between the rotational axle and the brackets becomes complicated.

As a result, hinge devices for complementing the above problems have been proposed and are being used. However, it is difficult to correct an initially set pivoting torque and an open frictional force. Also, since the structures of the hinge devices are complicated, the effects are not being greatly exhibited.

### SUMMARY OF THE INVENTION

To solve the above problems, it is an object of the present invention to provide a hinge device for use in electric or electronic equipment, which has effects of a simple assembly and an easy maintenance, and can freely adjust a torque transferred to a rotational axle to thus generate a proper frictional force constantly and adjust a rotational angle according to an angle formed by the upper and lower contacting portions of the holder.

To accomplish the above object of the present invention, there is provided a hinge device for use in electric or electronic equipment comprising: a lower bracket; vertical plates which are vertically and opposingly installed with respect to each other on the central portion of the lower bracket, each vertical plate having an inwardly protruding stopper on the upper portion thereof, a rotational axle around the center portion of which a coil spring is wound to support the lower bracket and an upper bracket, and around the axle groove of which a snap ring is fitted, the rotational axle being placed across the upper portions of the vertical plates; a connection plate placed across the upper portions of the vertical plates, the connection plate having a fixing hole and a fixing unit on each end thereof; a band spring which is fitted into each end of the rotational axle, an engagement unit being attached to the band spring and being adjusted with washers and an adjustment bolt; and the upper bracket having two supporters each of which has a holder including an upper contacting portion and a lower contacting portion which contact the protruding stopper respectively and an axle hole through which the rotational axle is fitted.

According to another aspect of the present invention, there is also provided a hinge device for generating a predetermined pivoting movement by movement of a rotating portion with respect to a fixed portion around a hinge, the hinge device comprising: a lower bracket in which a support bar and a support hole are formed; vertical plates which are vertically and opposingly installed with respect to each other on the central portion of the lower bracket, each vertical plate having an inwardly protruding stopper on the upper portion thereof and a fixing hole through which a fixing pin in the rotational axle can be inserted; a rotational axle around the center portion of which a coil spring is wound to support the lower bracket and an upper bracket, and around the axle groove of which a snap ring is fitted, in which a fixing pin and a fixing bolt are formed on the outer circumference of the rotational axle; a band spring which is adjusted with washers and an adjustment bolt at each end of the rotational axle; and the upper bracket on which an upper contacting portion and a lower contacting portion are formed, having an axle hole and an engagement hole through which the band spring is fitted.

Preferably, the rotational axle is configured to have a driving axle where an axle groove and a snap ring are formed in a portion coupled with the band spring and a fixing pin and an insertion bolt are formed on the circumference thereof, and a fixed axle 323 coupled with a coil spring, which is formed of an outer axle holder and an inner insertion nut.

### BRIEF DESCRIPTION OF THE DRAWINGS

The above object and other advantages of the present invention will become more apparent by describing the preferred embodiments thereof in more detail with reference to the accompanying drawings in which:

FIG. 1 is a perspective view showing the overall structure of a hinge device of the present invention;

FIG. 2 is an exploded perspective view for explaining the assembly process of the hinge device according to the present invention;

FIG. 3 is a sectional view partly showing the hinge device according to another embodiment of the present invention; and

FIG. 4 is a perspective view showing the hinge device according to still another embodiment of the present invention;

FIG. 5 is a developing view showing the assembly process of the FIG. 4 hinge device;

FIG. 6 is a perspective view showing the hinge device according to yet another embodiment of the present invention; and

FIG. 7 is a developing view showing the assembly process of the FIG. 6 hinge device.

### DETAILED DESCRIPTION OF THE INVENTION

Preferred embodiments of the present invention will be described with reference to the accompanying drawings.

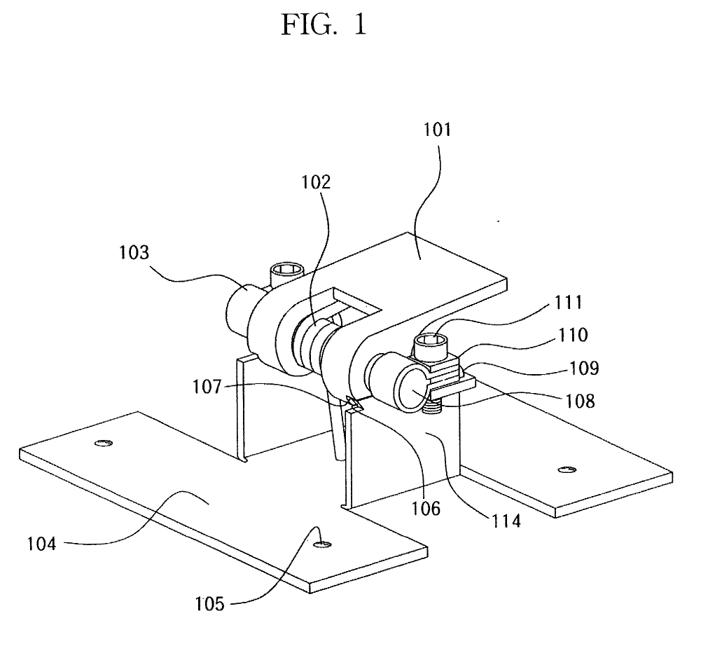

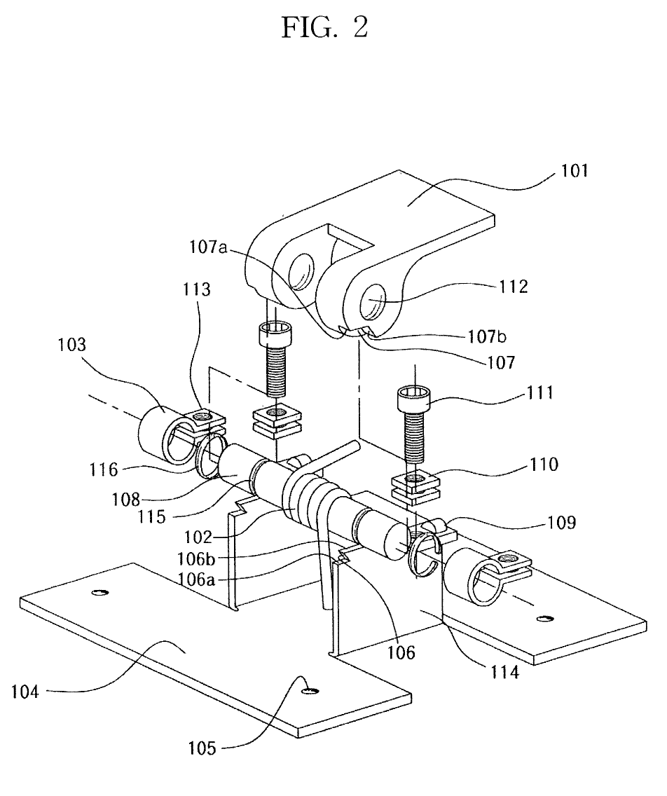

Referring to FIGS. 1 and 2, a hinge device according to the present invention includes a lower bracket 104 which is fixed through fixing holes 105 to a fixed portion (not shown) by means of a general connection structure, and vertical plates 114 formed vertically and opposingly with respect to each other on the central portion of the upper portion of the lower bracket 104, are integrated with the lower bracket 104. A protruding stopper 106 formed of an upper face 106b and a lower face 106a is formed on the upper portion of each vertical plate 114. A rotational axle 108 is placed across the vertical plates 114, in which a coil spring 102 having a predetermined tension, to support the lower bracket 104 and an upper bracket 101 is wound around the central portion of the rotational axle 108 and a snap ring 116 is fitted around a rotational axle groove 115 formed on each end of the rotational axle 108. A connection plate 117 formed of a fixing unit 109 and a fixing hole 118 on each end thereof is placed across the vertical plates 114. A band spring 103 is fitted into each end of the rotational axle 108, in which an engagement unit 113 is attached to the band spring 103 and is adjusted with washers 110 and an adjustment bolt 111 which are fixed by the fixing unit 109. When the rotational axle 108 is pivoted, the upper bracket 101 having two supporters each of which has a holder 107 including an upper contacting portion 107a and a lower contacting portion 107b which contact the upper face 106b and the lower face 106a of the protruding stopper 106 respectively and an axle hole 112 through which the rotational axle 108 is fitted, is engaged with a pivoting portion (not shown).

The functions of the hinge device according to the present invention will be described below.

The lower bracket 104 on which the vertical plates 114 are integrated is fixed through fixing holes 105 to a fixed portion (not shown) by means of a general connection structure.

The rotational axle 108 has an elastic force by the coil spring 102 having a predetermined tension. In order to adjust the elastic force, the band spring 103 for maintaining a predetermined frictional force is fitted into the left and right ends of the rotational axle 108, respectively. Also, the snap ring 116 is fitted around the rotational axle groove 115 formed on each end of the rotational axle 108, in order to prevent the left and right movement of the rotational axle 108.

In order to smoothen the friction with the rotational axle 108, a lubricant such as grease is filled into the band springs 103.

Here, in order to freely adjust the torque transferred to the rotational axle 108 and thus generate an appropriate frictional force constantly, the band spring 103 is fixed around the rotational axle groove 115 formed on each end of the rotational axle 108 with the adjustment bolt 111.

Two washers 110 or the like are fitted with the adjustment bolt 111, in order to prevent the adjustment bolt 111 from being loosened. Also, in order to prevent the washers 110 from being idly rotated when the washers 110 are engaged with the adjustment bolt 111, the fixing unit 109 is fitted on the upper portion of the connection plate 117.

The coil spring 102 is fitted around the rotational axle 108, and then the rotational axle 108 is inserted into the rotational axle holes 112 formed in the upper bracket 101. Then, the upper bracket 101 is engaged with a pivoting portion (not shown).

When the upper bracket 101 is pivoted by the rotational axle 108, the upper contacting portion 107a and the lower contacting portion 107b formed in the upper bracket 101 contact the upper face 106b and the lower face 106a of the protruding stopper 106 formed in the vertical plate 114 respectively, to thereby maintain a predetermined rotational angle.

The lower contacting portion 107b contacts the upper face 106b by the elastic force of the coil spring 102 unless the upper bracket 101 is pivoted.

When the upper bracket 101 is pivoted downwards, a force is applied to offset the elastic force of the coil spring 102 and the frictional force of the band spring 103, both of which are wound around the rotational axle 108. In this case, the upper bracket 101 is pivoted downwards by the frictional force of the band spring 103 wound around the rotational axle 108. Here, the upper bracket 101 is smoothly pivoted downwards due to the elastic force of the coil spring 102 formed on each end of the rotational axle 108, and stopped at the time when the lower contacting portion 107b of the upper bracket 101 contacts the upper face 106b of the stopper 106 in the vertical plate 114.

Also, when the upper bracket 101 is pivoted upwards, a force is applied to offset the elastic force of the coil spring 102 and the frictional force of the band spring 103, both of which are wound around the rotational axle 108. In this case, the upper bracket 101 is pivoted upwards by the elastic force of the coil spring 102 wound around the rotational axle 108. Here, the upper bracket 101 is smoothly pivoted upwards due to the frictional force of the band spring formed on each end of the rotational axle 108, and stopped at the time when the upper contacting portion 107a of the upper bracket 101 contacts the lower face 106a of the stopper 106 in the vertical plate 114.

As described above, it is preferable that the holder 107 formed of the upper contacting portion 107a and the lower contacting portion 107b has a groove of a predetermined thickness for each kind of electric or electronic equipment, so that the upper bracket 101 is easily pivoted.

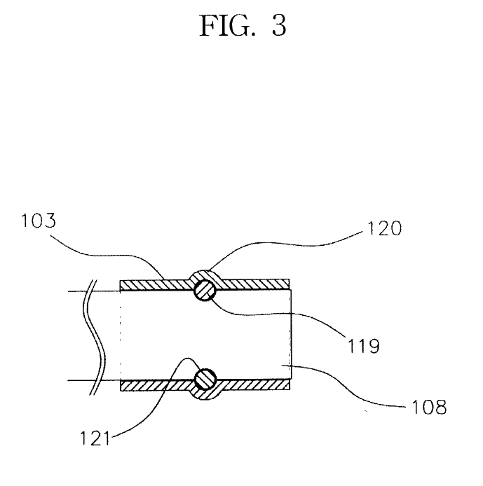

FIG. 3 is a sectional view partly showing the hinge device according to another embodiment of the present invention.

Referring to FIG. 3, a ball rotating portion 120 is formed on the central portion of a band spring 103 installed in each end of a rotational axle 108. A groove is provided so that an upper ball 119 and a lower ball 121 can be fitted around the rotational axle 108 contacting the ball rotating portion 120.

In FIG. 3, when the upper bracket 101 is pivoted, the friction of the band springs 103 with the rotational axle 108 is further smoothened due to the ball rotating portion 120 and the upper and lower balls 119 and 121.

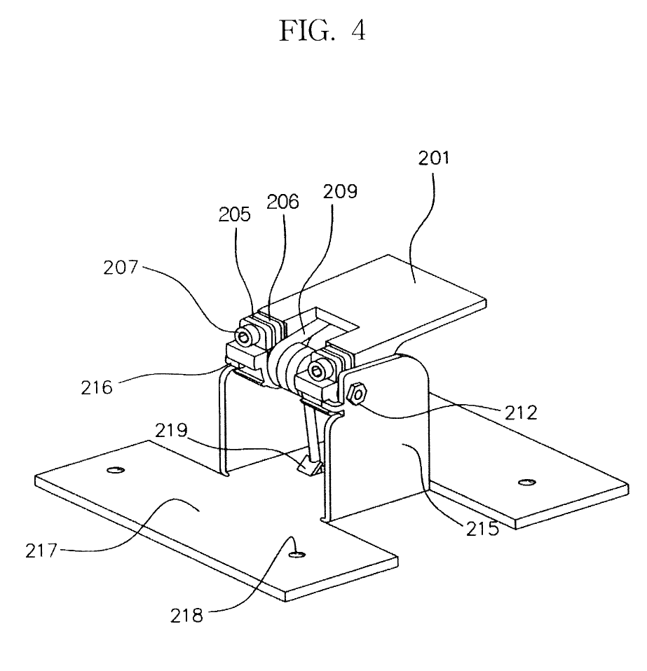

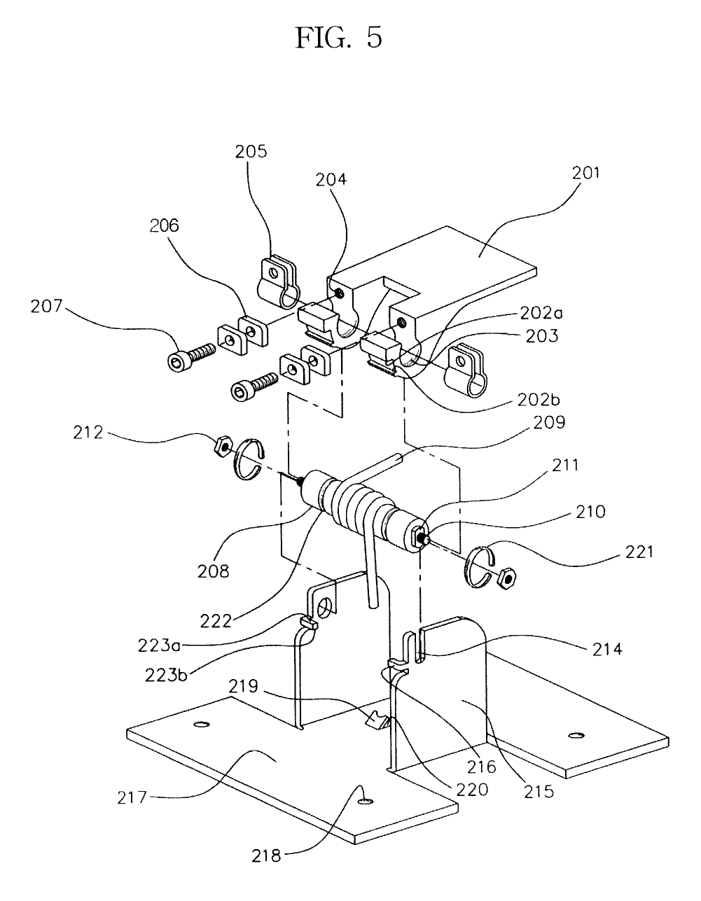

FIG. 4 is a perspective view showing the hinge device according to still another embodiment of the present invention, and FIG. 5 is a developing view showing the assembly process of the FIG. 4 hinge device.

Referring to FIGS. 4 and 5, a hinge device according to still another embodiment of the present invention includes a lower bracket 217 which is fixed through fixing holes to a fixed portion (not shown) by means of a general connection structure, and vertical plates 215 integrally formed on the upper portion of the lower bracket 217. A protruding stopper 216 formed of an upper face 223b and a lower face 223a is formed on either side of each vertical plate 215. A fixing hole 214 is formed on one side of the upper surface of each vertical plate 215 so that a fixing pin 211 of a rotational axle 208 can be inserted thereinto, and a circular hole is formed on the other side of the upper surface of each vertical plate 215 so that a circular axle which is a portion of the rotational axle 208 can be inserted thereinto. A coil spring 209 having a predetermined tension, to support the lower bracket 217 and an upper bracket 201 is wound around the central portion of the rotational axle 208 in which part of the coil spring 208 is inserted into a supporting hole 220 in a supporting bar 219 formed on the bottom of the lower bracket 217. A snap ring 221 is fitted around a rotational axle groove 222 formed on each end of the rotational axle 208. The rotational axle 208 formed with a fixing bolt 210 is fixed to the upper portion of the vertical plates 215 by means of a fixing nut 212. A band spring 205 is fitted into each end of the rotational axle 208, in which the band spring 205 is adjusted with washers 206 and an adjustment bolt 207. When the rotational axle 208 is pivoted, the upper bracket 201 including an upper contacting portion 202a and a lower contacting portion 202b which contact the upper face 223b and the lower face 223a of the protruding stopper 216 respectively, an axle hole 203 through which the rotational axle 208 is fitted, and a connection hole 204 with which the adjustment bolt 207 is engaged, is engaged with a pivoting portion (not shown).

The functions of the hinge device according to the present invention will be described below. The lower bracket 217 on which the vertical plates 215 are integrated is fixed through fixing holes to a fixed portion (not shown) by means of a general connection structure.

The rotational axle 208 has an elastic force by the coil spring 102 having a predetermined tension. In order to adjust the elastic force, the band spring 205 for maintaining a predetermined frictional force is fitted into the left and right ends of the rotational axle 208, respectively. Also, the snap ring 221 is fitted around the rotational axle groove 222, in order to prevent the left and right movement of the rotational axle 208.

In order to smoothen the friction with the rotational axle 208, a lubricant such as grease is filled into the band springs 205.

Here, in order to freely adjust the torque transferred to the rotational axle 208 and thus generate an appropriate frictional force constantly, the band spring 205 is fixed to the rotational axle 208 with the adjustment bolt 207.

Two washers 206 or the like are fitted with the adjustment bolt 207, in order to prevent the adjustment bolt 207 from being loosened. Also, since the adjustment bolt 207 is engaged with a connection hole 204 formed in the upper bracket 201, the tension of the band spring 205 can be adjusted.

The coil spring 209 is fitted around the rotational axle 208, and then the band spring 205 is wound around both sides of the rotational axle 208 to be fitted on the axle hole 203 and fixed to the upper bracket 201 with an adjustment bolt 207. Then, the upper bracket 201 is engaged with a pivoting portion (not shown).

When the upper bracket 201 is pivoted by the rotational axle 208, the upper contacting portion 202a and the lower contacting portion 202b formed in the upper bracket 201 contact the lower face 223a and the upper face 223b of the protruding stopper 216 respectively, to thereby maintain a predetermined rotational angle.

The lower contacting portion 202b contacts the upper face of 223b of the protruding stopper 216 by the elastic force of the coil spring 209 unless the upper bracket 201 is pivoted.

When the upper bracket 201 is pivoted downwards, a force is applied to offset the elastic force of the coil spring 209 and the frictional force of the band spring 205, both of which are wound around the rotational axle 208. In this case, the upper bracket 201 is pivoted downwards by the elastic force of the coil spring 209 wound around the rotational axle 208. Here, the upper bracket 201 is smoothly pivoted downwards, and stopped at the time when the lower contacting portion 202b of the upper bracket 201 contacts the upper face 223b of the stopper 216.

Also, when the upper bracket 201 is pivoted upwards, a force is applied to offset the elastic force of the coil spring 209 and the frictional force of the band spring 205, both of which are wound around the rotational axle 208. In this case, the upper bracket 201 is pivoted upwards by the elastic force of the coil spring 209 wound around the rotational axle 208. Here, the upper bracket 201 is smoothly pivoted upwards due to the frictional force of the band spring 205 formed on each end of the rotational axle 208, and stopped at the time when the upper contacting portion 202a of the upper bracket 201 contacts the lower face 223a of the stopper 216.

As described above, it is preferable that the upper contacting portion 202a and the lower contacting portion 202b has a groove of a predetermined thickness for each kind of electric or electronic equipment, so that the upper bracket 201 is easily pivoted.

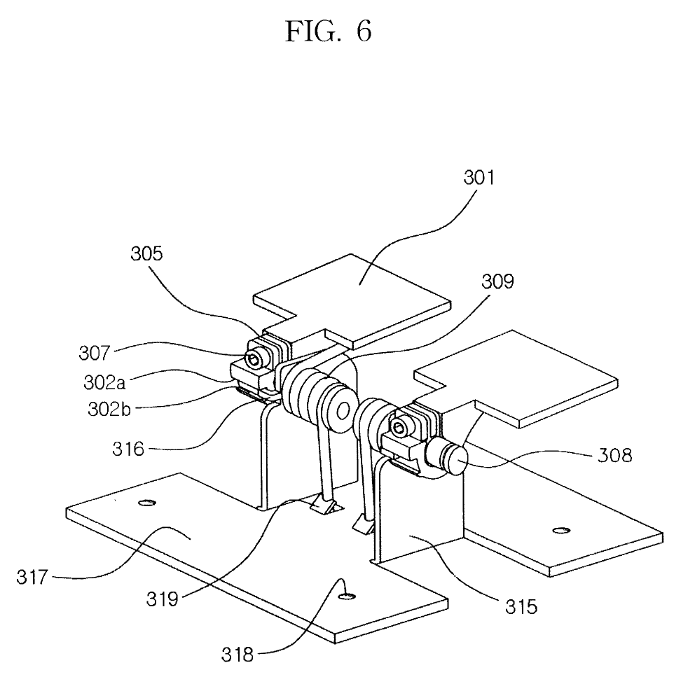

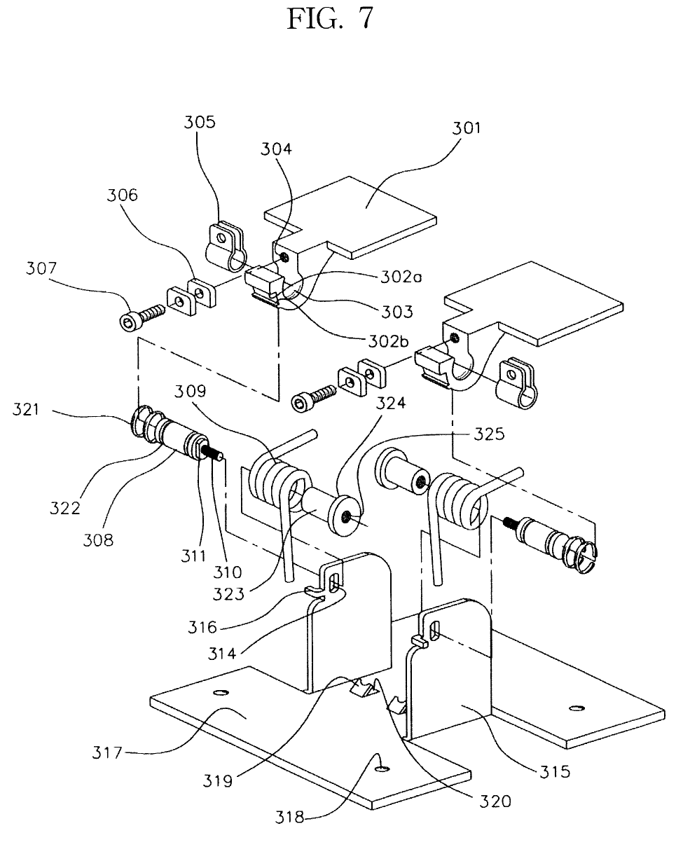

FIG. 6 is a perspective view showing the hinge device according to yet another embodiment of the present invention, and FIG. 7 is a developing view showing the assembly process of the FIG. 6 hinge device.

Referring to FIGS. 6 and 7, a hinge device according to yet another embodiment of the present invention includes a lower bracket 317 which is fixed through fixing holes to a fixed portion (not shown) by means of a general connection structure, and vertical plates 315 integrally formed on the upper portion of the lower bracket 317. A protruding stopper 316 formed of an upper face 323b and a lower face 323a is formed on either side of each vertical plate 315. A fixing hole 314 is formed on the upper surface of each vertical plate 315 so that a fixing pin 311 of a driving axle 308 can be inserted thereinto. A coil spring 309 having a predetermined tension, to support the lower bracket 317 and an upper bracket 301 is wound around a fixed axle 323 in which part of the coil spring 308 is inserted into a supporting hole 320 in a supporting bar 319 formed on the bottom of the lower bracket 317. A snap ring 321 is fitted in a rotational axle groove 322.

The driving axle 308 is formed with a fixing pin and an insertion bolt 310. The fixed axle 323 is formed of an insertion nut 325 through which the insertion bolt 310 of the driving axle 308 is inserted, and an axle holder 324. The band spring 305 which are adjusted by washers 306 and an adjustment bolt 307 is coupled with the central portion of the driving axle 308. Accordingly, the band spring 305 is fitted into an axle hole 303 of the upper bracket 301.

When the rotational axle 308 is pivoted, the upper bracket 301 including an upper contacting portion 302a and a lower contacting portion 302b which contact the upper face 323b and the lower face 323a of the protruding stopper 316 respectively, an axle hole 303 through which the driving axle 308 is fitted, and a connection hole 304 with which the adjustment bolt 307 is engaged, is engaged with a pivoting portion (not shown).

The functions of the hinge device according to the present invention will be described below. The lower bracket 317 on which the vertical plates 315 are integrated is fixed through fixing holes to a fixed portion (not shown) by means of a general connection structure.

The fixed axle 323 has an elastic force by the coil spring 309 having a predetermined tension. In order to adjust the elastic force, the band spring 305 for maintaining a predetermined frictional force is fitted into the driving axle 308. Also, the snap ring 321 is fitted into the axle groove 322, in order to prevent the left and right movement of the driving axle 308.

The axle holder 324 is formed on the fixed axle 323 in order to prevent the coil spring 309 from being released externally.

In order to smoothen the friction with the driving axle 308, a lubricant such as grease is filled into the band springs 305.

Here, in order to freely adjust the torque transferred to the driving axle 308 and thus generate an appropriate frictional force constantly, the band spring 305 is fixed to the driving axle 308 with the adjustment bolt 307.

Two washers 306 or the like are fitted with the adjustment bolt 307, in order to prevent the adjustment bolt 307 from being loosened. Also, since the adjustment bolt 307 is engaged with a connection hole 304 formed in the upper bracket 301, the tension of the band spring 305 can be adjusted.

The coil spring 309 is fixed to the fixed axle 323, and then is fitted into a support hole 320 formed on a support bar 319 in the upper and lower brackets 301 and 317, respectively.

The band spring 305 is wound around the driving axle 308 to be fitted on the axle hole 303 and fixed to the upper bracket 301 with an adjustment bolt 307. Then, the upper bracket 301 is engaged with a pivoting portion (not shown).

When the upper bracket 301 is pivoted by the driving axle 308, the upper contacting portion 302a and the lower contacting portion 302b formed in the upper bracket 301 contact the lower face 323a and the upper face 323b of the protruding stopper 316 respectively, to thereby maintain a predetermined rotational angle.

The lower contacting portion 302b contacts the upper face of 323b of the protruding stopper 316 by the elastic force of the coil spring 309 unless the upper bracket 301 is pivoted.

When the upper bracket 301 is pivoted downwards, a force is applied to offset the elastic force of the coil spring 309 wound around the fixed axle 323 and the frictional force of the band spring 305 wound around the driving axle 308. In this case, the upper bracket 301 is pivoted downwards by the elastic force of the coil spring 309 wound around the fixed axle 323. Here, the upper bracket 301 is smoothly pivoted downwards, and stopped at the time when the lower contacting portion 302b of the upper bracket 301 contacts the upper face 323b of the stopper 316.

Also, when the upper bracket 301 is pivoted upwards, a force is applied to offset the elastic force of the coil spring 309 wound around the fixed axle 323 and the frictional force of the band spring 305 wound around the driving axle 308. In this case, the upper bracket 301 is pivoted upwards by the elastic force of the coil spring 309 wound around the fixed axle 323. Here, the upper bracket 301 is smoothly pivoted upwards due to the frictional force of the band spring 305 formed on each end of the driving axle 308, and stopped at the time when the upper contacting portion 302a of the upper bracket 301 contacts the lower face 323a of the stopper 316.

As described above, it is preferable that the upper contacting portion 302a and the lower contacting portion 302b has a groove of a predetermined thickness for each kind of electric or electronic equipment, so that the upper bracket 301 is easily pivoted.

As described above, the hinge device according to the present invention has effects of a simple assembly and an easy maintenance, and can freely adjust a torque transferred to the rotational axle to thus generate a proper frictional force constantly and adjust a rotational angle according to an angle formed by the upper and lower contacting portions of the holder.

The present invention is not limited to the above-described embodiments. It is apparent to one who has an ordinary skill in the art that there may be many modifications and variations within the same technical spirit of the invention.

What is claimed is:

1. A hinge device for use in electric or electronic equipment, the hinge device comprising:
a lower bracket (104);
vertical plates (114) which are vertically and opposingly installed with respect to each other on the central portion of the lower bracket (104), each vertical plate (114) having an inwardly protruding stopper (106) on the upper portion thereof;
a rotational axle (108) around the center portion of which a coil spring (102) is wound to support the lower bracket (104) and an upper bracket (101), and around the axle groove (115) of which a snap ring (116) is fitted, the rotational axle (108) being placed across the upper portions of the vertical plates (114);
a connection plate (117) placed across the upper portions of the vertical plates (114), the connection plate (117) having a fixing hole (118) and a fixing unit (109) on each end thereof;
a band spring (103) which is fitted into each end of the rotational axle (108), an engagement unit (113) being attached to the band spring (103) and being adjusted with washers (110) and an adjustment bolt (111); and
the upper bracket (101) having two supporters (107) each of which has a holder including an upper contacting portion (107a) and a lower contacting portion (107b) which contact the protruding stopper respectively and an axle hole (112) through which the rotational axle (108) is fitted.

2. The hinge device of claim 1, wherein a ball rotating portion (120) is formed on the central portion of the band spring (103) installed in each end of the rotational axle (108) and a groove is formed in the rotational axle (108) contacting the band spring (103) so that an upper ball (119) and a lower ball (121) can be fitted.

3. A hinge device for generating a predetermined pivoting movement by movement of a rotating portion with respect to a fixed portion around a hinge, the hinge device comprising:
a lower bracket (217) in which a support bar (219) and a support hole (220) are formed;
vertical plates (215) which are vertically and opposingly installed with respect to each other on the central portion of the lower bracket (217), each vertical plate (215) having an inwardly protruding stopper (216) on the upper portion thereof and a fixing hole (214) through which a fixing pin (211) in the rotational axle (208) can be inserted;
a rotational axle (208) around the center portion of which a coil spring (209) is wound to support the lower bracket (217) and an upper bracket (201), and around the axle groove (222) of which a snap ring (221) is fitted, in which a fixing pin (211) and a fixing bolt (210) are formed on the outer circumference of the rotational axle (208);
a band spring (205) which is adjusted with washers (206) and an adjustment bolt (207) at each end of the rotational axle (208); and
the upper bracket (201) on which an upper contacting portion (202a) and a lower contacting portion (202b) are formed, having an axle hole (203) and an engagement hole (204) through which the band spring (205) is fitted.

4. A hinge device for generating a predetermined pivoting movement by movement of a rotating portion with respect to a fixed portion around a hinge, the hinge device comprising:
a lower bracket (317) in which a support bar (319) and a support hole (320) are formed;
vertical plates (315) which are vertically and opposingly installed with respect to each other on the central portion of the lower bracket (317), each vertical plate (315) having an inwardly protruding stopper (316) on the upper portion thereof and a fixing hole (314) through which a fixing pin (311) in the pair of rotational axle (308) can be inserted;
a pair of rotational axle (308) around the center portion of which a pair of coil spring (309) is wound to support the lower bracket (317) and an upper bracket (301), and around the axle groove (322) of which a snap ring (321) is fitted, in which a fixing pin (311) and a fixing bolt (310) are formed on the outer circumference of the rotational axle (308);
a band spring (305) which is adjusted with washers (306) and an adjustment bolt (307) at each end of the pair of rotational axle (208); and
the pair of upper bracket (301) on which an upper contacting portion (302a) and a lower contacting portion (302b) are formed, having an axle hole (303) and an engagement hole (304) through which the band spring (305) is fitted.
